(19) United States
(12) Patent Application Publication
(10) Pub. No.: US 2025/0324507 A1
(43) Pub. Date: Oct. 16, 2025

(54) OVEN ASSEMBLY FOR PRODUCING SPATIALLY PROPAGATING ATOMS

(71) Applicant: Oxford University Innovation Limited, Oxford (GB)

(72) Inventors: Joseph F. GOODWIN, Oxford (GB); Jacob A. BLACKMORE, Oxford (GB); Thomas H. DOHERTY, Oxford (GB); William J. HUGHES, Oxford (GB)

(21) Appl. No.: 18/869,361

(22) PCT Filed: May 26, 2023
(86) PCT No.: PCT/GB2023/051408

§ 371 Date: Nov. 26, 2024

(30) Foreign Application Priority Data
May 31, 2022 (GB) 2208026.1

(51) Int. Cl. H05H 3/02; G21K 1/00

(52) U.S. Cl. CPC H05H 3/02; G21K 1/00

(57) ABSTRACT

An oven assembly (104) for producing spatially propagating neutral atoms. The oven assembly (104) includes: a first housing (108) configured to house atomic source material (110), at least one passage (134) from an interior of the first housing (108) to an exterior of the first housing (108), a second housing (120), and one or more supports (124). The first housing (108) is held in a fixed position relative to the second housing (120) by the one or more supports (124). The first housing (108), the second housing (120) and the one or more supports (124) are formed from a first homogeneous material.

The present invention relates generally to an oven assembly for producing spatially propagating neutral atoms, such as a neutral atomic beam suitable for loading an ion trap in an ion trap quantum computer.

In recent years, ion traps have been demonstrated to be a viable technology for developing a large-scale quantum computer for quantum information processing and direct quantum simulation. However, a number of obstacles exist which must be overcome in order to scale up current ion trap systems to large enough numbers of qubits to achieve so-called quantum advantage, wherein a quantum computer is able to solve certain problems faster than is possible using any classical computer.

One envisaged route to scalability is to produce a single large quantum processor from a network of many ion trap nodes housed within individual ultra-high vacuum systems, where each node is of relatively low complexity containing a small number of ion qubits. Accordingly, to reach a suitable number of qubits, each node and in-vacuum components thereof must be relatively compact whilst also minimising the impact on the quality of the vacuum in which the qubits reside.

One such example of an in-vacuum component is the atomic source which is used to load the ion trap. An atomic source generates a neutral atomic beam directed towards a desired target ion trapping region. So as to load the ion trap, the neutral atoms are subsequently ionised, e.g. via a photo-ionisation laser beam directed orthogonal to the direction of the atomic beam. Currently, typical atomic sources consist of collimated thermal beams generated from resistively heated ovens or laser ablation sources, e.g. as disclosed in U.S. Pat. No. 10,923,335 B2.

These methods have limits to their applicability for scalable ion trap systems. Resistively heated ovens generally require high-current electrical feedthroughs and in-vacuum wiring, increasing warm-up time, reducing reliability and thermal efficiency, and often making them incompatible with cryogenic vacuum systems. Laser ablation sources offer fast response times and cryogenic compatibility, but require a high energy pulsed laser source to be integrated within or directed to each system. In addition, such ablation sources generate plumes of neutral atoms with high and variable stream velocity, reducing the fraction of ionised particles that can be trapped in shallow ion traps, and increasing Doppler effects which limit isotopic selectivity in the photoionisation process.

These prior approaches lead to an atomic beam for which only a small portion of the produced atoms are trappable (which increases the background pressure of the vacuum system and the time or number of attempts required to load ions). Each may also involve a relatively complex and/or poorly thermally isolated assembly, which correspondingly increases both the in-vacuum surface area of components and contributes to undesirable heating of the surrounding system. This typically leads to increased error rates and reliability issues in the time following loading of an ion qubit.

The present application seeks to address one or more of these issues.

In one aspect, the present invention provides an oven assembly for producing spatially propagating neutral atoms, wherein the oven assembly comprises: a first housing configured to house atomic source material; at least one passage from an interior of the first housing to an exterior of the first housing; a second housing; and one or more supports, wherein the first housing is held in a fixed position relative to the second housing by the one or more supports; wherein the first housing, the second housing and the one or more supports are formed from a first homogeneous material.

It is sometimes difficult to provide an oven assembly which has a sufficient degree of mechanical stability (e.g. between internal components of the oven assembly), as well as providing a high thermal impedance between the oven assembly and the surrounding environment. For instance, various components of a conventional oven assembly are formed of different materials. Some components of one type of material can be configured to provide mechanical stability, whereas other components of a second material may be configured to provide high thermal impedance.

However, problems exist, such as different thermal coefficients of expansion, or difficulties in joining the two materials, which may contribute to decreased mechanical stability and/or lower thermal impedance. In contrast, embodiments of the present invention provide an oven assembly wherein the first housing, second housing, and one or more supports are all formed from the same homogeneous material. This arrangement helps to overcome problems with conventional arrangements.

The first housing may be held in a fixed position and with a high degree of thermal isolation relative to the second housing by the one or more supports.

The oven assembly may comprise an integral piece comprising the first housing and the one or more supports. As such, as there are no joins between the first housing and the one or more supports, the oven assembly piece may have a uniform thermal coefficient of expansion and a uniform material structure throughout the integral piece, which may increase the mechanical stability and/or increase the thermal impedance.

As will be understood, the spatially propagating neutral atoms may be a neutral atomic beam.

In embodiments, the oven assembly comprises an integral piece consisting of the first housing, the second housing, and the one or supports, wherein the first housing comprises the at least one passage.

The first housing may comprise the at least one passage. For instance, the at least one passage may be provided through a wall of the first housing. In embodiments, the first housing is held in a fixed position relative to the second housing only by the one or more supports. That is, the only material route for thermal transmission through the oven assembly itself is between the first housing and the second housing is via the one or more supports.

As will be understood, the second housing may not be a housing of a vacuum chamber (i.e. a vacuum housing). Rather, the second housing may be configured to be mounted into the housing of a vacuum chamber, or may be configured to be mounted into a structure, wherein the structure is configured to be mounted into the housing of a vacuum chamber.

In embodiments, (i) one or more regions of a surface of the first housing is configured to be heated by irradiation from a light source, so as to liberate atoms from the atomic source material housed therein; and/or (ii) the first housing is configured to house the atomic source material such that one or more regions of a surface of the atomic source material housed therein is configured to be heated by irradiation from a light source, so as to liberate atoms from the atomic source material; wherein the at least one passage is configured so as to allow the liberated atoms to pass therethrough to form the spatially propagating neutral atoms.

As will be understood, when the first housing is heated, the source material contained therein increases in temperature, leading to an increased vapour pressure of the source material within the first housing and an effusion of source material from any open apertures in the housing (e.g. through the at least one passage), producing one or more plumes of spatially propagating neutral atoms or one or more neutral atomic beams.

A first region of the one or more regions may be an outer surface of the first housing. For instance, the first region may be an outer surface defining or adjacent to the at least one passage.

Alternatively or additionally, a second region of the one or more regions may be an inner surface of the first housing, such as an inner surface of the at least one passage, or an inner surface of the interior of the first housing. In these embodiments, the first housing is configured to be heated by irradiation from a light source directed at least partially through the at least one passage.

Alternatively or additionally, the first housing and the at least one passage may be configured such that a surface of the atomic source material housed in the first housing is heated by irradiation from a light source directed at least partially through the at least one passage. In embodiments comprising a plurality of passages, irradiation from a light source may be directed at least partially through at least one passage of the plurality of passages to heat the atomic source material.

Although the first housing may be configured to be heated by irradiation from a light source, it will be understood that other heating methods may be used such as resistive heating, without departing from the scope of the disclosure.

In embodiments in which the first housing is configured to be heated by a light source, the light source may be a laser.

In embodiments, the first housing is held in a fixed position within the second housing so as to be at least partially enclosed or surrounded by the second housing.

For instance, the second housing may be an annular outer housing. The one or more supports may support the first housing so as to position the first housing radially inwards of the annular outer housing.

In embodiments, the oven assembly comprises a plurality of passages, and wherein: (i) the first housing comprises a plurality of chambers configured to house atomic source material, and wherein each of the plurality of passages is from an interior of a respective one of the plurality of chambers to an exterior of the first housing; or (ii) the first housing comprises a chamber configured to house atomic source material, and wherein each of the plurality of passages is from an interior of the chamber to an exterior of the first housing.

For instance, the first housing may comprise the plurality of passages.

In embodiments, each one of the plurality of passages is from an interior of the same chamber to an exterior of the first housing. A first passage of the plurality of passages may be provided on a first side of the chamber. A second passage of the plurality of passages may be provided on a second side of the chamber opposing the first. As will be appreciated, the first passage may be the passage, in use, through which the liberated atoms pass to form the spatially propagating atoms. In contrast, the second passage may be a passage through which: (i) the source material may be loaded into the chamber of the first housing; and/or (ii) an end of an optical fibre is inserted. The optical fibre may be for transmitting radiation from an EM source, such that one or more regions of a surface of the atomic source material housed therein may heated by irradiation from the inserted end of the optical fibre.

The first housing may comprise only a single chamber. That is, the oven assembly may be formed from a single monolithic piece. For instance, the first housing, the second housing, and the one or supports consists of only the first homogeneous material. As will be appreciated this may simplify the manufacture of the oven assembly.

In another aspect, there is provided a method of fabricating the oven assembly of any of the embodiments described herein. During fabrication of the oven assembly, the method may comprise the steps of: (i) forming a first portion of the first housing; (ii) loading atomic source material onto the first portion of the first housing; and (iii) forming a second portion of the first housing on the first portion of the first housing so as to provide the first housing configured to house atomic source material, wherein the first housing comprises the at least one passage.

The method may further comprise loading atomic source material via insertion through the at least one passage. For instance, the initial atomic source material may be depleted through use of the oven assembly, and may subsequently be replenished via insertion through the at least one passage.

During fabrication of the oven assembly, the method may comprise the steps of: (i) forming the first housing configured to house atomic source material, wherein the first housing comprises the at least one passage; and (ii) loading atomic source material into the first housing via insertion through the at least one passage. Loading atomic source material into the oven assembly may be achieved via evaporation through a shadow mask.

As will be understood, in these ways at least the first housing, configured to house atomic source material, may be fabricated as a single monolithic piece.

In embodiments, the oven assembly comprises: a first piece comprising the first housing, at least a portion of the second housing, and at least a portion of the one or more supports; and a second piece comprising at least one cap configured to engage with the first housing.

For instance, the at least one cap is configured to engage with the first housing, so as to form a chamber in which the atomic source material is housed, so as to seal the atomic source material within the chamber. That is, the first housing and the at least one cap may be configured to mutually engage with each other so as to form a volume within an interior of the first housing in which the atomic source material is housed and sealed. The first housing may comprise the at least one passage, and may further comprise an open end having a diameter or width larger than the diameter or width of the at least one passage, wherein the open end is configured to be closed by the at least one cap.

As will be understood, to “seal” the atomic source material means that liberated atoms from the atomic source material are substantially only able to leave the interior of the first housing through the at least one passage.

The (e.g. first housing of the) first piece may include a plurality of passages and the second piece may comprise either a single cap or a plurality of caps, for instance such that each cap of the plurality of caps corresponds to a respective passage of the plurality of passages. For example, in embodiments in which the oven assembly comprises a plurality of passages and a corresponding plurality of chambers configured to house atomic source material, each cap of the plurality of caps may be configured to engage with or seal a respective chamber of the plurality of chambers, such that each chamber is closed other than for the corresponding passage from the interior of the chamber to an exterior of the first housing.

In embodiments in which the oven assembly comprises a single chamber and a plurality of passages from an interior of the single chamber to an exterior of the first housing, a single cap may be configured to engage with or seal the single chamber, such that the single chamber is closed other than for the plurality of passages from the interior of the single chamber to an exterior of the first housing.

The first and second pieces may each comprise one or more mating surfaces. Each mating surface of the one or more mating surfaces of one of the first and second piece may be configured, in use, to contact a corresponding mating surface of the other of the first and second piece.

One or more regions of a surface of the at least one cap may be configured to be heated by irradiation from a light source, so as to heat and liberate atoms from the atomic source material housed within the first housing, and wherein the liberated atoms pass through the at least one passage to form the spatially propagating neutral atoms.

In embodiments, the second piece is bonded to the first piece, for instance by anodic, optical contact, eutectic, thermocompression, adhesive, brazed or sintered bonds. For instance, the at least one cap may be bonded to the first housing by anodic, optical contact, eutectic, thermocompression, adhesive, brazed or sintered bonds. In embodiments, the at least one cap is attached to the first housing by clips or a friction fit.

In embodiments, the second piece further comprises an outer cap housing, and one or more cap supports, wherein the at least one cap is held in a fixed position relative to the outer cap housing by the one or more cap supports, optionally wherein, when the second piece is arranged to engage with the first piece, the one or more cap supports is configured to bias the at least one cap against the first housing, so as to seal the first housing with the at least one cap.

For instance, during assembly, the second piece may be brought into contact with the first piece and/or the first and second pieces may be located at designated positions in an external structure, such that the one or more cap supports biases or forces the least one cap onto and against the first housing, so as to mutually seal with each other.

Alternatively or additionally, the at least a portion of the one or more supports of the first piece, in use, may similarly be configured to force the first housing against the at least one cap, so as to seal the first housing with the at least one cap.

The at least a portion of the second housing of the first piece and the outer cap housing of the second piece may together form the second housing of the oven assembly.

The at least a portion of the one or more supports of the first piece and the one or more cap supports of the second piece may together form the one or more supports of the oven assembly.

In embodiments, the second piece is formed from a second homogeneous material. For instance, the at least one cap, the outer cap housing, and the one or more cap supports may be formed from the same homogenous material, which may be the homogenous material of the first piece, or may be a different homogeneous material. The second piece may consist only of a second homogeneous material. In embodiments, the first homogenous material and the second homogeneous material are the same homogenous material.

As will be appreciated, forming both the first and second pieces from the same homogeneous material may simplify fabrication, and may improve the thermal and mechanical properties of the oven assembly, e.g. because the first and second pieces may exhibit the same coefficients of thermal expansion.

In embodiments, the at least one cap comprises at least one cap passage therethrough so as to provide, when engaged with the first housing, the at least one passage, so as to fluidically connect an interior of the first housing to an exterior of the at least one cap.

For instance, the first housing may be closed other than for an open end, and the cap, comprising at least one cap passage therethrough, may be configured to close the open end of the first housing other than for the at least one cap passage, so as to provide the one or passage of the oven assembly.

In embodiments, each of the first and second pieces is an integral piece. That is, components of the first piece (e.g. the first housing, at least a portion of the second housing, and at least a portion of the one or more supports) consist of only the first homogeneous material, and components of the second piece (e.g. the at least one cap, the outer cap housing, and/or the one or cap supports) consist of only the first homogeneous material, wherein each piece is separate and integral.

The oven assembly may be formed from two pieces, wherein each piece is a single monolithic piece. As will be appreciated this helps to reduce the manufacturing complexity as there is no need for precise location of the one or more supports with respect to the first or second housings.

For instance, the homogeneous material may be: glass, fused-silica, silicon-based, carbon-based, amorphous, polymer and/or ceramic. Accordingly, in embodiments in which the whole of the oven assembly is a single integral piece, the oven assembly may be manufactured from a single monolithic block via laser-enhanced etching, such as femtosecond-laser-assisted chemical etching.

In embodiments in which the first and second pieces together provide the oven assembly and each of the first and second pieces is an integral piece, each piece may be manufactured from a respective single monolithic block via laser-enhanced etching, such as femtosecond-laser-assisted chemical etching.

In embodiments, the first housing comprises the at least one passage. The at least one cap may comprise at least one cap passage therethrough. As such, when the at least one cap is engaged with the first housing, the at least one passage may be provided on an opposing side of an interior of the first housing to the at least one cap passage. As will be appreciated, one of the first housing passage or the cap passage may be the passage, in use, through which the liberated atoms pass to form the spatially propagating atoms. In contrast, the other of the first housing passage or the cap passage may be a passage through which: (i) the source material may be loaded into the chamber of the first housing; and/or (ii) an end of an optical fibre is inserted, wherein the optical fibre may be for transmitting radiation from an EM source, such that one or more regions of a surface of the atomic source material housed therein and/or an interior surface of the first housing may heated by irradiation from the inserted end of the optical fibre.

In embodiments, the oven assembly comprises a third housing. The third housing may at least partially surround the first piece and the second piece, and wherein the third housing may be configured to bias the first piece and the second piece together so as to seal the first housing with the at least one cap.

The third housing may comprise: a third housing cap; a clip; and a stop on an interior surface of the third housing. The clip may be configured to bias the third housing cap in a direction towards the top so as to bias the first and second pieces together against the stop.

The third housing cap may have an aperture therethrough. As will be appreciated, the aperture may provide passage for an optical fibre tip (i.e. an end of an optical fibre) to be inserted therethrough. As the third housing cap is positioned further away from the interior of the first housing in use (which is the hottest region), the region of the aperture in the third housing cap may be relatively cooler. As such, an adhesive may advantageously be used in the aperture of the third housing cap so as to secure a portion of the optical fibre to the third housing cap.

In embodiments, the one or more supports, or the one or more cap supports, comprise one or more spokes, membranes, filaments or combinations thereof. For instance, in embodiments in which there are no cap supports, the one or more supports may comprise one or more spokes, membranes, filaments or combinations thereof. In embodiments comprising one or more cap supports, the one or more supports and/or the one or more cap supports may comprise one or more spokes, membranes, filaments or combinations thereof.

In embodiments, the spokes comprise a plurality of spiral spokes. In embodiments, the plurality of spiral spokes comprise a first set of spiral spokes rotating in a first direction and a second set of spiral spokes rotating in a second direction opposite to the first direction, wherein at least one spiral spoke from one of the first or second sets mechanically intersects at least one spiral spoke from the other of the first or second sets. In embodiments, the plurality of spiral spokes comprise a first set of spiral spokes rotating in a first direction and a second set of spiral spokes rotating in a second direction opposite to the first direction, wherein each spoke of the first and second sets does not mechanically intersect any other spoke of the first and second sets.

In embodiments, the at least one passage has an aspect ratio of at least 2:1, defined as the ratio of the length with respect to the diameter, such that the spatially propagating neutral atoms are collimated through the at least one passage from the interior to the exterior to form a neutral atomic beam.

In embodiments, the aspect ratio is one of: between 2:1 and 10:1, between 10:1 and 30:1, between 30:1 and 50:1, or greater than 50:1. Each or all of the at least one passage may have a diameter of: less than 1 micron, between 1 micron and 15 microns, between 15 microns and 50 microns, between 50 microns and 100 microns, or greater than 1000 microns. Each or all of the at least one passage may have a length of: less than 50 microns, between 50 microns and 250 microns, between 250 microns and 500 microns, between 500 microns and 1000 microns, or greater than 1000 microns. The first housing may have a volume of: less than 0.01 mm³, between 0.01 mm³ and 0.1 mm³, between 0.1 mm³ and 1 mm³, between 1 mm³ and 10 mm³, or greater than 10 mm³.

In embodiments, the oven assembly comprises a plurality of passages arranged substantially in parallel so as to form an array of distinct spatially propagating neutral atoms. That is, in embodiments in which each of the plurality of passages has a sufficiently high aspect ratio, an array of substantially parallel neutral atomic beams may be formed.

In embodiments, the oven assembly may comprise a plurality of passages which are not parallel so as to form distinct spatially propagating neutral atoms or a plurality of neutral atomic beams directed in mutually non-parallel directions.

In embodiments, the oven assembly comprises a layer on an outer surface region of the oven assembly. Preferably the layer has a thickness of at least 10 nm. Thus preferably the layer has thickness substantially smaller than the dimensions of the oven assembly, such that the layer is a thin layer or coating. The layer may have a thickness of less than a micron.

At least a part of the outer surfaces of the first housing, the second housing and/or the one or more supports may comprise the layer. Preferably the majority of the outer surfaces of the first housing, the second housing and/or the one or more supports comprise the layer.

In embodiments in which one or more regions of a surface of the first housing is configured to be heated by irradiation from a light source, the one or more regions may be an uncoated region which does not comprise the layer.

The layer may be a metallic layer or a dielectric layer. In embodiments, if the layer is a dielectric layer, the layer may have a thickness of more than a micron. Preferably the layer is a metallic layer.

The layer may be, e.g., a sputter coating, a coating achieved via evaporative deposition, or a coating deposited via wet chemistry. The layer may comprise a first layer, such as an adhesive layer, and a second layer, such as a blackbody emissivity reduction layer.

In embodiments wherein the layer is metallic, the metallic layer may be a titanium/gold (Ti/Au) sputter coating, or any other suitable coating, such as via evaporated Au and Ti.

The Ti may be the adhesive layer, to enable and ameliorate adhesion. The adhesive layer may have a thickness of approximately 1 nm, 1-10 nm, or greater than 10 nm. Alternative materials may be used as an adhesive layer of the metallic layer. For instance, the adhesive layer may be a single layer stack, e.g. of platinum.

The Au may be the blackbody emissivity reduction layer. The blackbody emissivity reduction layer may have a thickness greater than 10 nm, such as between 10 nm and 100 nm, between 100 nm and 200 nm, or greater than 200 nm.

The metallic layer may comprise a migratory prevention layer, such as one or more (e.g. further) layers configured to prevent migration between the (e.g. Ti) adhesive layer and the (e.g. Au) blackbody emissivity reduction layer. This may be particularly the case at higher temperatures. Thus, the metallic layer may be configured to reduce blackbody emissivity of the oven assembly. Any region of the oven assembly which does not comprise the metallic layer may improve ingress of energy from a light source into the interior of the first housing. The interior of the first housing may be configured to be heated via conduction of heat from the exterior of the first housing when the exterior of the first housing is irradiated by a light source.

The homogeneous material of the first housing, the second housing and the one or more supports may be substantially transparent to the irradiation from the light source. Accordingly, one or more outer surface regions of the oven assembly may be an uncoated region which does not comprise the thin metallic layer, so as to enable irradiation from a light source to be directed at least partially through the uncoated region and through the substantially transparent homogeneous material to heat one or more regions of an interior surface of the first housing or a surface of the atomic source material housed in the first housing. In embodiments configured such that the surface of the atomic source material is heated by the irradiation from the light source, the first housing may comprise a thin metallic layer on an interior surface of the first housing (i.e. the surface of the first housing which faces the atomic source material housed therein).

The oven assembly may comprise a thin metallic layer on an inner surface region of the oven assembly, such as on an interior surface of the first housing. This may be advantageous, for example, in embodiments in which the first housing and the at least one passage are configured such that a surface of the atomic source material housed in the first housing is heated by irradiation from a light source directed at least partially through the at least one passage.

The oven assembly may comprise (e.g. contain) the atomic source material, for instance, the atomic source material may be calcium.

In another aspect, there is provided a system for producing spatially propagating neutral atoms, the system comprising: an oven assembly as in any of the preceding embodiments; and a heating mechanism for heating the oven assembly so as to liberate atoms from the atomic source material housed therein, and wherein the liberated atoms pass through the at least one passage to form the spatially propagating neutral atoms.

In embodiments, the heating mechanism comprises a source of electromagnetic (EM) radiation configured to irradiate one or more regions of a surface of the first housing configured to be heated by irradiation from the light source, one or more regions of a surface of the at least one cap configured to be heated by irradiation from the light source and/or one or more regions of a surface of the atomic source material.

The EM source of electromagnetic radiation may be a light source. The EM source may be a laser. The laser may be a pulsed laser. Preferably the laser is a continuous wave laser.

In embodiments, the EM source may be located at a distance away from the oven assembly. For instance, if the oven assembly is placed within a vacuum system for use within the vacuum, the EM source may be placed outside of the vacuum system (e.g. configured to irradiate onto the oven assembly through a window in the vacuum system from a position outside of the window). This may further decrease the heat load within the vacuum system and simplify the in-vacuum structure of components.

In embodiments, the EM source has a wavelength which substantially corresponds to a prominent absorption line of the first homogeneous material and/or the second homogeneous material.

In embodiments, the system comprises an optical fibre arranged to transmit radiation from the EM source to the oven assembly. As will be appreciated, using an optical fibre allows radiation to be transmitted from the EM source even when there is no direct line of sight between the EM source and the oven assembly.

An end of the optical fibre may be inserted through an aperture of the first housing of the oven assembly so as to be configured to irradiate an interior surface of the first housing and/or the atomic source material. This may increase the efficiency of energy transmission from the EM source to the source material housed within the first housing of the oven assembly.

In another aspect, there is provided an ion trap system, the ion trap system comprising the oven assembly of any of the embodiments described herein and an ion trap comprising an ion trapping region, wherein the at least one passage is configured to direct the atomic beam towards the ion trapping region.

Such configurations help to ensure that the oven assembly is highly thermally insulated, with lower power losses which may be at, or below, 10 mW, such as between 1 mW and 10 mW, or below 1 mW. Moreover, for loading an ion trap, the system for producing a neutral atomic beam may be configured to continuously generate a neutral atomic beam at a relatively low flux.

For instance, the system for producing a neutral atomic beam, in use, may generate an atomic beam having a flux of: less than 100 atoms/s, between 100 and 104 atoms/s, between 104 and 106 atoms/s, or greater than 106 atoms/s. Preferably, the atomic beam may be generated with a flux of around 103 atoms/s.

The system may comprise one or more photo-ionisation lasers configured to ionise atoms from the neutral atomic beam so as to produce ions for trapping within the ion trapping region.

In another aspect, there is provided a method for producing a neutral atomic beam using the system of any of the embodiments described herein, the method comprising: (i) with the heating mechanism, heating the oven assembly so as to liberate atoms from the atomic source material; and (ii) producing the spatially propagating neutral atoms from at least some of the liberated atoms passing through the at least one passage.

In embodiments in which the heating mechanism comprises a light source or laser, the method may also comprise performing an initial cracking operation, comprising: (i) with the light source or laser, irradiating the oven assembly (e.g. the first housing) so as to liberate particles from an oxide layer on the atomic source material at a first temperature; (ii) producing spatially propagating particles (e.g. a particle beam) from at least some of the liberated particles passing through the at least one passage; (iii) directing the spatially propagating particles into a dump region of a surrounding structure; (iv) with the light source or laser, irradiating the oven assembly so as to liberate atoms from the atomic source material at a second temperature lower than the first temperature; and (v) producing spatially propagating neutral atoms (e.g. a neutral atomic beam) from at least some of the liberated atoms passing through the at least one passage. As will be understood, the temperature can be controlled, e.g. via the light source or laser intensity, the light source or laser wavelength, and/or the duration of time over which the light source or laser is on.

The passage may be an aperture or a collimator. It may sometimes be difficult to provide an oven assembly that produces a collimated neutral atomic beam formed of atoms liberated from atomic source material. Conventionally, this problem is overcome by using a collimator. However, collimators may become at least partially clogged/blocked, for instance due to aggregation of liberated atoms along the inner surface of the channel of the collimator. As a result, conventional collimators have a restriction on the lower limit of the channel diameter, such that they cannot produce relatively highly collimated neutral atomic beams. In contrast, some embodiments of the present invention provide an oven assembly wherein, in use, the collimator is hotter than the first housing which houses the atomic source material, as it is the collimator which is configured to be directly heated by a laser, whereas the first housing is heated via conduction of heat from the collimator. This arrangement helps to overcome problems with conventional arrangements.

The collimator may be configured to be heated by a light source or a laser in a similar manner as described above. The collimator may comprise a substantially conical body surrounding the passage therethrough. As will be appreciated, the collimator having a conical body may enable the oven assembly to be positioned closer to target region (e.g., the exit of the passage of collimator may be positioned closer to target region).

The first housing and/or the second housing may comprise an end face which faces the direction of propagation of the spatially propagating neutral atoms or neutral atomic beam, and wherein the collimator extends beyond the end face of the first housing and/or second housing in the direction of propagation of the neutral atomic beam.

The first region of the outer surface of the collimator which is configured to be heated by a light source or laser may therefore be located on a side surface of the collimator facing orthogonal to the direction of propagation of the neutral atomic beam.

The end face of the second housing may extend (in the direction of propagation of the spatially propagating neutral atoms or neutral atomic beam) beyond the end face of the first housing, and the collimator may extend beyond the end face of the first housing but not beyond the end face of the second housing.

The collimator may comprise: a first portion around at least a part of the channel, the first portion having a first radial thickness; and a second portion around at least a part of the channel at the end of the collimator in the direction of propagation of the spatially propagating neutral atoms or neutral atomic beam, the second portion having a second radial thickness greater than the first radial thickness; wherein: (i) the first and second portions have a substantially constant first and second radial thicknesses, respectively, as a function of position along the collimator in the direction of propagation of the neutral atomic beam; or (ii) the first portion has a first radial thickness which increases as a function of position along the collimator in the direction of propagation of the neutral atomic beam.

The collimator may comprise: a third portion around at least a part of the channel; a circular disc sector end plate; and a partial annulus radially outside the third portion and connected to the circular disc sector end plate, wherein the same angle subtends both the partial annulus and the circular disc sector end plate, such that the partial annulus partially surrounds the third portion.

The oven assembly may comprise: a first piece comprising the collimator; and a second piece, wherein the first and second pieces together form the first housing. The first piece providing the collimator and the second piece may together form the second housing, and may each comprise one or more supports which support the first housing and/or the collimator within the second housing.

Thus, the structure of the oven assembly according to embodiments help to enable the inner housing (housing the atomic source material) and collimator attached thereto to be substantially thermally isolated from the outer housing. That is, the one or more supports mechanically support the inner housing and/or the collimator within the outer housing, whilst providing a relatively long thermal path length between the outer housing and the inner housing and/or collimator, such that the outer housing (and the surrounding system) are substantially thermally isolated from the hotter regions of the oven assembly (being the inner housing and collimator).

The system comprising the light source, such as a laser, and the oven assembly may comprise: (i) the light source or laser being configured to be incident on a front portion of the collimator, wherein the front portion of the collimator faces the direction in which the spatially propagating neutral atoms or neutral atomic beam propagates; or (ii) the light source or laser being incident on a side portion of the collimator, wherein the side portion does not face the direction in which the neutral atomic beam propagates, optionally wherein the side portion faces a direction orthogonal to the direction in which the neutral atomic beam propagates.

For instance, the light source or laser may be configured to be substantially counter-propagating with respect to the neutral atomic beam so as to be incident on the front portion of the collimator, or the laser may be configured to be directed substantially orthogonal to the direction in which the spatially propagating neutral atoms or the neutral atomic beam propagates so as to be incident on the side portion of the collimator.

Accordingly, the present invention helps to allow the oven assembly to be placed very close to the desired target region with negligible impact to the trapping system, whilst helping to ensure micron level transverse alignment of the atomic beam to the target, and with negligible tilt. For instance, the oven assembly may be located at a position from the target region of: less than 0.1 mm, between 0.1 mm and 1 mm, between 1 mm and 5 mm, or greater than 5 mm.

Various embodiments of the invention will now be described, by way of example only, and with reference to the accompanying drawings in which:

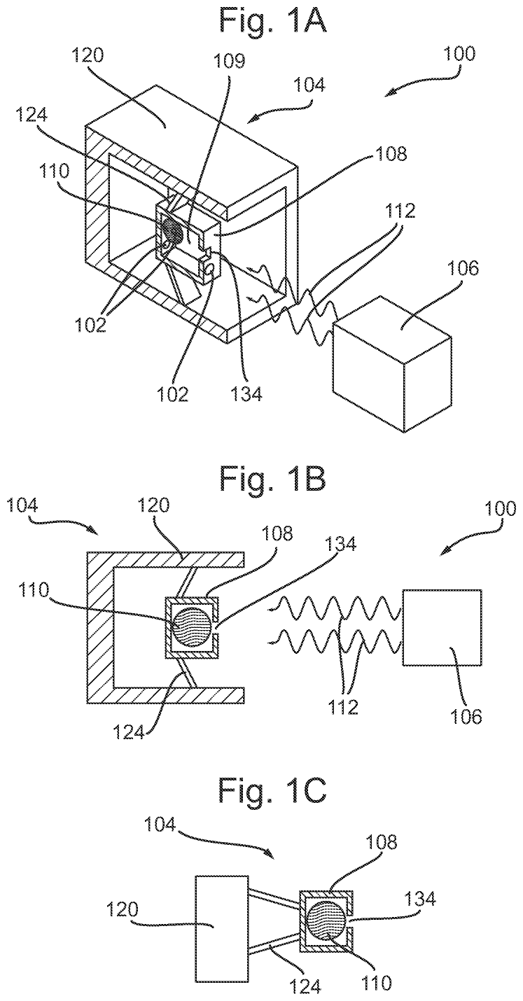

FIGS. 1A and 1B show two different perspective views of some of the principal components of a system for producing spatially propagating neutral atoms, according to an embodiment of the invention; FIG. 1C shows an oven assembly, according to an embodiment of the invention.

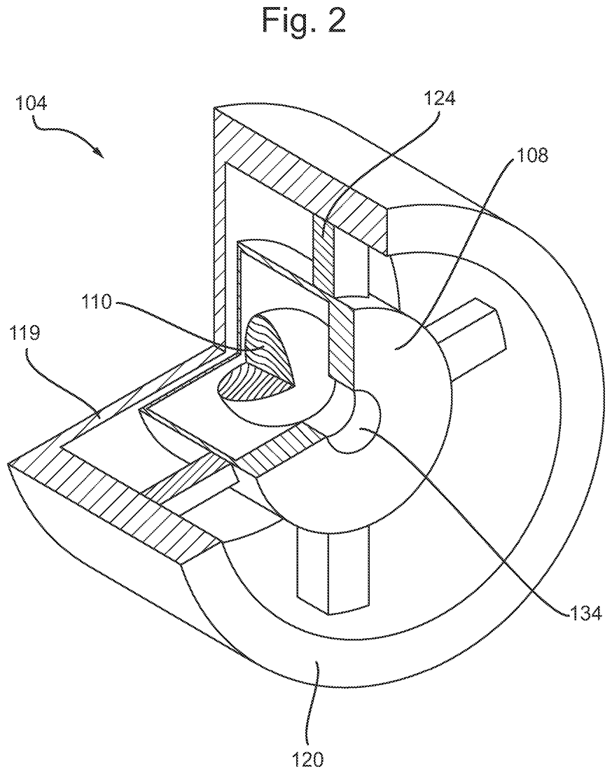

FIG. 2 shows an oven assembly, according to a further embodiment of the invention.

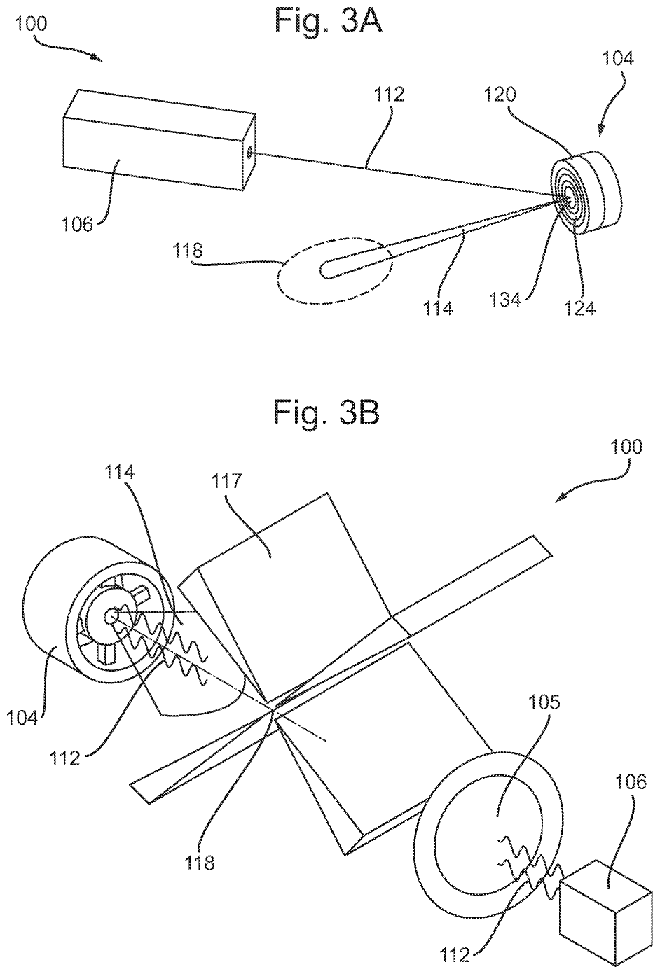

FIGS. 3A and 3B show some of the principal components of a system for spatially propagating neutral atoms for directing towards a target region, according to respective different embodiments of the invention.

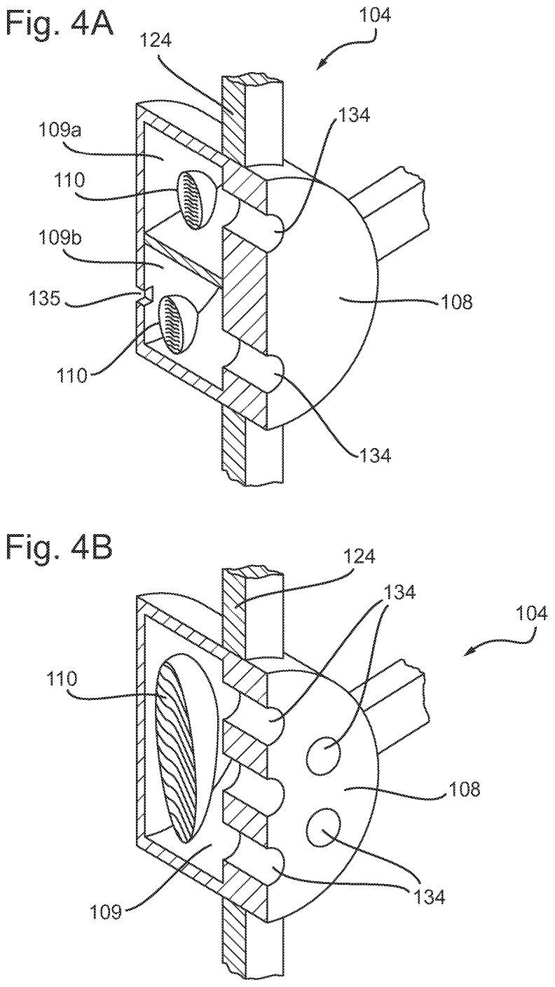

FIGS. 4A and 4B each show an oven assembly, according to respective different embodiments of the invention.

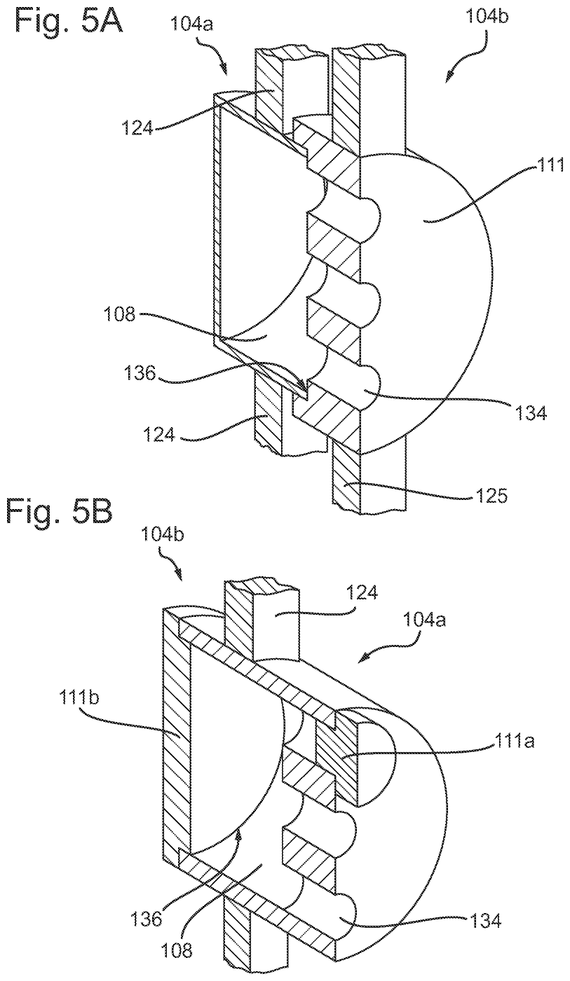

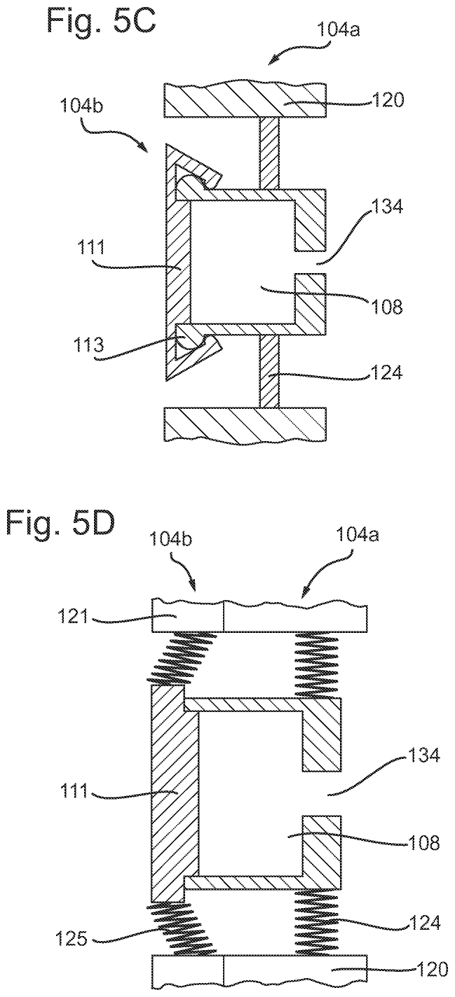

FIGS. 5A-5D each show an oven assembly formed from at least two pieces, according to respective different embodiments of the invention.

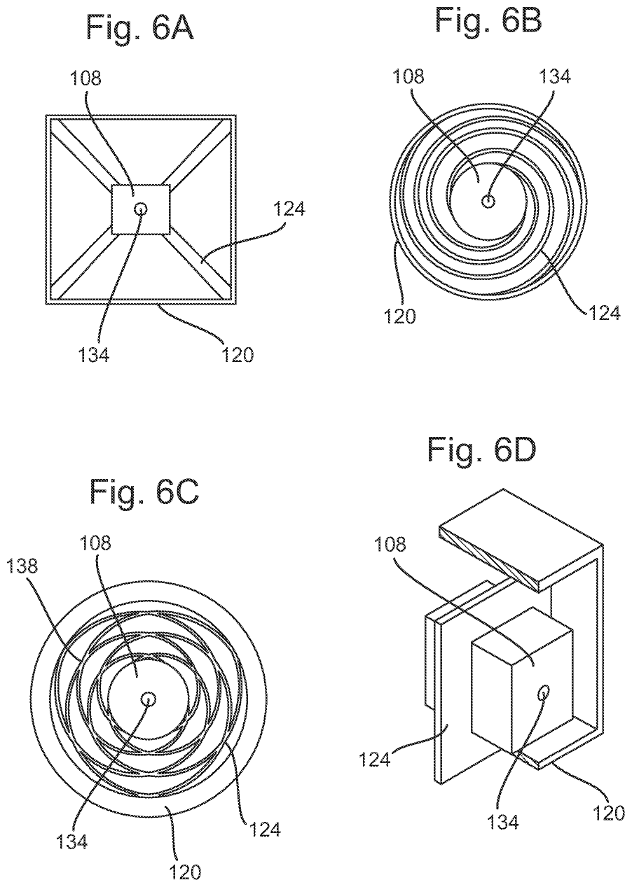

FIGS. 6A-6D each show an oven assembly, according to respective different embodiments of the invention.

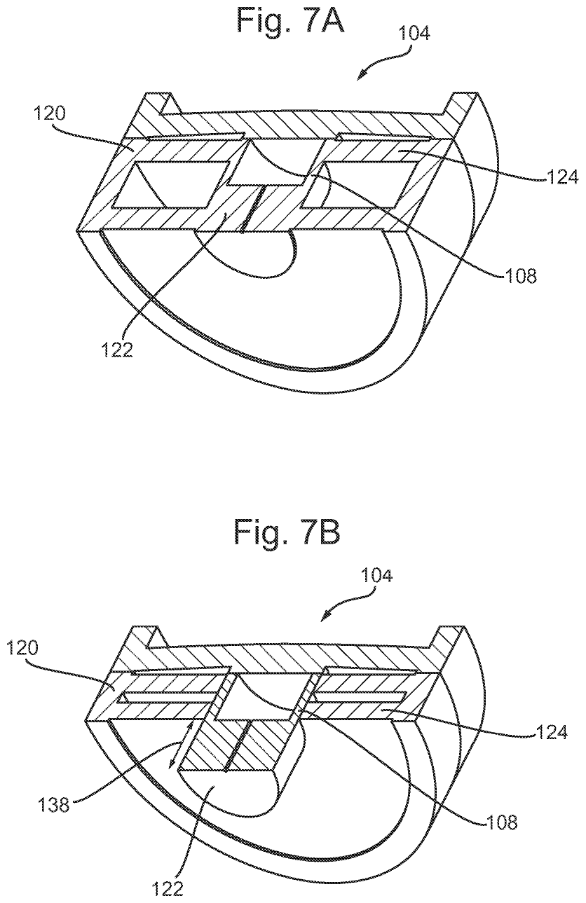

FIGS. 7A-7B show cross-sections along a middle-plane of two different embodiments of collimator geometries, according to respective different embodiments of the invention.

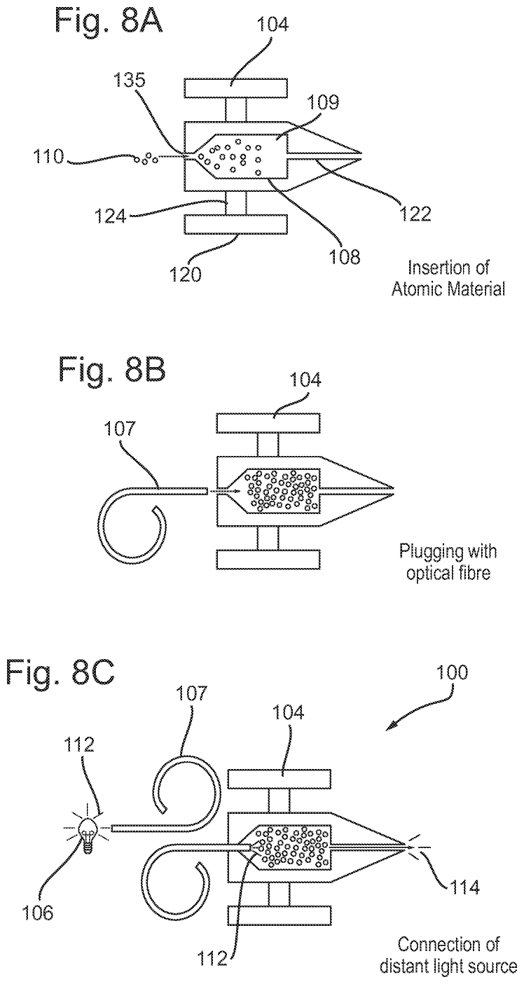

FIG. 8 shows a cross-sectional side-on view of three stages for configuring a system for producing spatially propagating neutral atoms, according to an embodiment of the invention.

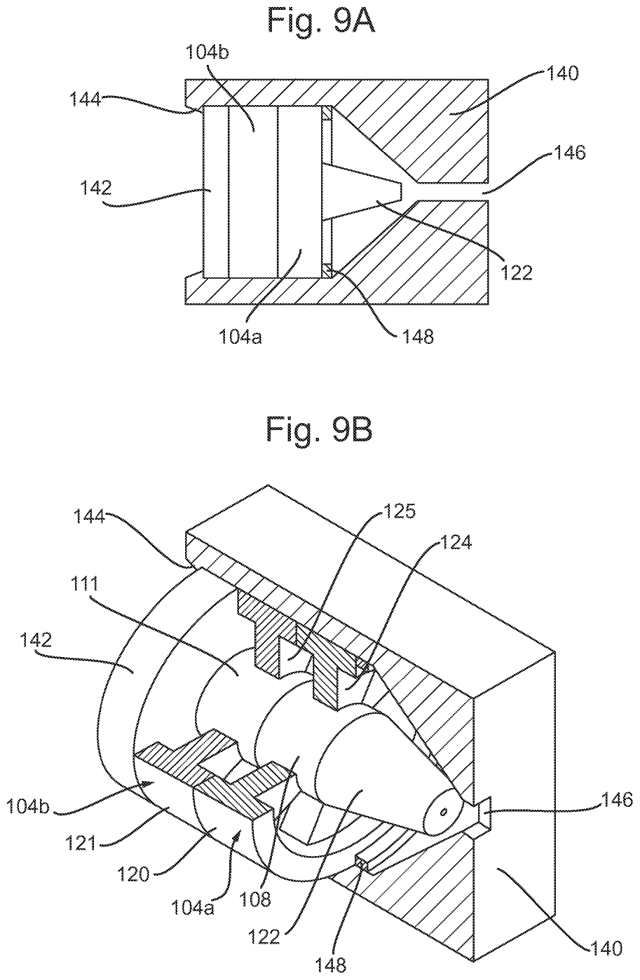

FIG. 9A shows a cross-sectional side-on view of an oven assembly, according to a further embodiment of the invention; and FIG. 9B shows a perspective view of the oven assembly of FIG. 9A with some sections cut out.

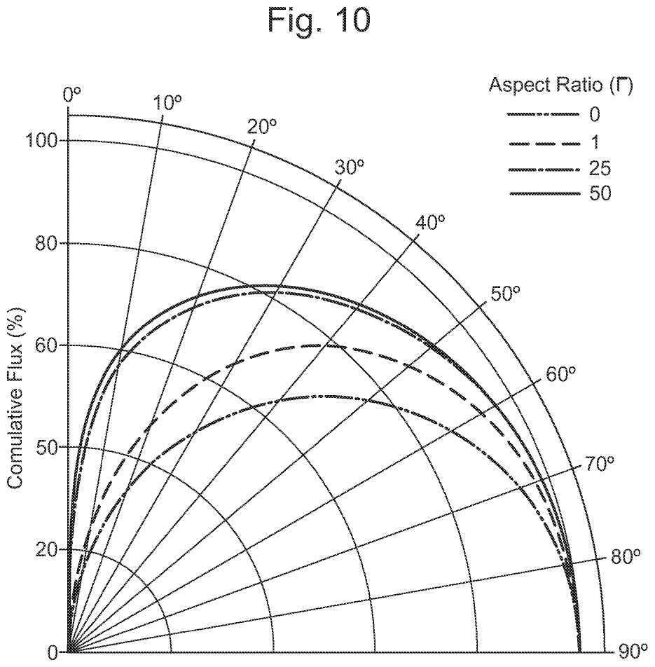

FIG. 10 shows a polar plot showing the percentage of atomic flux in an atomic beam that is within a given angle from the atomic beam axis from the collimator having different aspect ratios.

### OVEN ASSEMBLY

FIG. 1 shows a schematic of system 100 for producing spatially propagating neutral atoms (not shown), in accordance with an embodiment of the present invention. The system 100 includes an oven assembly 104 and an electromagnetic (EM) radiation source 106 for creating EM radiation 112. For instance, the EM radiation source 106 may be a light source, such as a laser source for creating a continuous wave laser beam or a pulsed laser beam. Preferably, the EM radiation source 106 is a continuous wave laser.

The oven assembly 104 is for housing source material 110 from which atoms are to be liberated to form the spatially propagating neutral atoms, wherein the source material 110 is contained within a first housing 108 of the oven assembly 104. For instance, the first housing 108 may provide at least one cavity forming an interior 109 of the first housing 108 in which the atomic source material 110 is housed.

The oven assembly 104 includes at least one passage 134 from an interior of the first housing 108 to an exterior of the first housing 108. For instance, as shown in FIGS. 1A-1C, the first housing 108 includes the at least one passage 134 from the interior 109 to an exterior of the first housing 108 in the form of an aperture through a wall of the first housing 108, which fluidically connects the interior 109 to the exterior thereof.

The oven assembly 104 also includes a second housing 120, and one or more supports 124 which hold the first housing 108 in a fixed position relative to the second housing 120. The first housing 108, the second housing 120, and the one or more supports 124 are all formed from a first homogeneous material.

As shown in FIG. 1A, the first housing 108 is held in a fixed position relative to the second housing only by the one or more supports 124 (i.e. only two supports 124 in FIG. 1A). In this way, the only material route for conductive thermal transmission through the oven assembly 104 from the first housing 108 to the second housing 120 (or vice versa) is through the one or more supports 124.

Still referring to FIG. 1A, the EM radiation 112 is directed towards the first housing 108 so as to impinge on one or more heating regions 102. For instance, the EM radiation 112 may be directed so as to impinge on an exterior surface of the first housing 108, such that the first housing 108 and subsequently the interior 109 of the first housing 108 are heated by the EM radiation 112. Alternatively or additionally, the EM radiation 112 may be directed so as to impinge on an interior surface of the first housing 108, e.g. by having at least a portion of the EM radiation 112 being directed through the at least one passage 134. Alternatively or additionally, the EM radiation 112 may also be directed so as to directly impinge on the atomic source material 110 housed within the first housing 108 (again, by having at least a portion of the EM radiation being directed through the at least one passage 134).

As a result of heating of the one or more heating regions 102, the atomic source material 110 housed within the first housing 108 is heated, e.g. by thermal conduction from the one or more heating regions 102 of a surface of the first housing 108 and/or via direct absorption of energy from the one or more heating regions 102 of a surface of the atomic source material 110. The atomic source material 110 is thus heated such that atoms are liberated from the source material 110, for example by melting and subsequent vaporization and/or sublimation of at least a part of the source material 110.

Due to the corresponding pressure differential thus induced between the interior 109 of the first housing 108 and the exterior thereof, the liberated atoms are therefore directed through the at least one passage 134 to form spatially propagating neutral atoms, such as a neutral atomic beam. In embodiments comprising a plurality of passages 134, irradiation from the EM radiation source 106 may be directed at least partially through at least one passage 134 of the plurality of passages 134 to heat the atomic source material 110.

FIG. 1B shows a side-on view of the system 100 of FIG. 1A. As shown, the first housing 108 may be held in a fixed position by the one or more supports 124 within the second housing so as to be at least partially enclosed or surrounded by the second housing. For instance, the second housing 120 may define a cavity within which the first housing 108 is held via the one or more supports 124, wherein the first housing 108 is at least partially within the cavity. For instance, in FIG. 1B the first housing 108 is shown fully within the cavity of the second housing 120. The cavity of the second housing 120 has an opening through which the spatially propagating neutral atoms generated in the first housing 108 may be directed.

Alternatively, as shown in FIG. 1C, the first housing 108 may be held in a fixed position relative to the second housing 120 so as to be adjacent to the second housing 120. In FIG. 1C, the second housing 120 is a base, such as a planar base, and the one or more supports 124 extend in a direction away from the base so as to hold the first housing 108 fixed a distance away from the base.

The first housing 108 and second housing 120 may have shapes which conform to each other, such as having substantially box-like shapes as shown in FIGS. 1A and 1B, wherein the box-like first housing 108 is held within a box-like rectangular cavity defined by the second housing 120. Alternatively, first housing 108 and second housing 120 may have shapes which are substantially different to each other, such as the box-like first housing 108 and the base second housing 122 in FIG. 1C.

The second housing 120 may be an annular outer housing 120, as shown in FIG. 2. Referring to FIG. 2, the one or more supports 124 may support the first housing 108 so as to position the first housing 108 radially inwards of the annular outer housing 120. The first housing 108 may generally conform to the shape of the annular outer housing 120. For instance, the first housing 108 in FIG. 2 is substantially cylindrical in shape. Alternatively, the first housing 108 may have a shape which does not conform with the annular outer housing 120, such as the first housing 108 being a box-like first housing.

The annular outer housing 120 may be open at both ends to define an annulus. Alternatively, as shown in FIG. 2, the annular outer housing 120 may have a closed end 119 such that there is only a single open end in the annular outer housing 120 through which the spatially propagating neutral atoms may be directed. Alternatively, the one or more supports 124 may hold the first housing 108 in a fixed position so as to partially protrude through an open end of the outer housing 120.

FIGS. 3A and 3B show some of the principal components of a system 100 for producing spatially propagating neutral atoms 114, such as a neutral atomic beam 114, for loading a particular target region 118 exterior to the oven assembly 104, such as an ion trapping region 118 (e.g., defined via ion trap electrodes 117), in accordance with embodiments of the present invention. FIG. 3A shows a system 100 for producing spatially propagating neutral atoms 114 having an oven assembly 104 and an EM radiation source 106 for creating EM radiation 112, wherein the EM radiation 112 is directed off-axis from the axis defining the principal direction of propagation of the neutral atomic beam 114.

The EM radiation source 106 may be a continuous wave laser source or a pulsed laser source. Preferably the EM radiation source 106 is a continuous wave laser source. The EM radiation 112 is configured to impinge upon the first housing 108 and/or directly onto source material 110 (e.g. through the at least one passage 134 of the oven assembly 104) so as to liberate one or more atoms from the source material 110 (preferably without ionising these one or more atoms), as discussed above.

The liberated atoms form spatially propagating neutral atoms 114 which are directed towards a suitable target region 118. As shown in FIG. 3B, the region 118 may be an ion trapping region 118 such as a linear ion trap, and the spatially propagating neutral atoms 114 may be ionised as they pass through region 118, for example through interaction with a part-resonant pair of UV lasers (not shown). Thus, the spatially propagating neutral atoms 114 can serve to provide the source necessary to load one or more ion traps associated with an ion trapping region 118.

Furthermore, as shown in FIG. 3B, the EM radiation source 106 can be spaced away from the oven assembly 104. For instance, if the oven assembly 104 is placed within a vacuum system (i.e. for use within a vacuum), the EM radiation source 106 can be placed outside of the vacuum system (e.g. configured to fire onto the oven assembly 104 through a window 105 in the vacuum system from a position on the other side of the window 105 than that of the oven assembly 104). This may help decrease the heat load within the vacuum system and simplifies the in-vacuum structure of components.

The EM radiation 112 may be directed substantially along the same axis defining the principal direction of propagation of the neutral atomic beam 114 as shown in FIG. 3B, or off-axis as shown in FIG. 3A. This flexibility may help reduce the complexities or difficulties associated with the positioning of the EM radiation source 106 with respect to other components within the broader system.

Referring to FIGS. 4A and 4B, the first housing 108 may include a plurality of passages 134 from an interior 109 of the first housing, such as two passages (FIG. 4A) or three passages (FIG. 4B). As shown in FIG. 4A, the first housing 108 may comprise a plurality of interior chambers 109a, 109b each of which is configured to house atomic source material 110, such as two interior chambers as shown. Each one of the passages 134 is from an interior of a respective one of the interior chambers 109a, 109b to an exterior of the first housing.

The lower-most interior chamber 109b is shown with a passage 134 which is front-facing and has a circular cross-section, and a back-facing passage 135 with a rectangular or square cross-section. The front-facing passage 134 is shown larger than the back-facing passage 135, in both length and cross-sectional area, and with a different cross-section. However, they may have the same cross-section and/or same length, and/or same cross-sectional area.

In embodiments, the back-facing passage 135 may enable heating the oven assembly from the rear, that is, directing the EM radiation 112 into the internal volume of the first housing through the back-facing passage 135.

In embodiments, the front-facing passage 134 may be smaller. The back-facing passage 135 may be a capillary for instance. It has been found that it may be desirable for effusion of an atomic beam through this back-facing passage. In embodiments, the back-facing passage 135 may be configured to direct spatially propagating neutral atoms in a rearward direction for diagnostic purposes, such as for measuring the temperature of the atoms. As will be understood, this may avoid the need to direct spectroscopy beams through more sensitive regions, such as the target region 118. In embodiments, the back-facing passage 135 may provide a means to load the source material, or additional source material, into the oven assembly. Providing multiple passages or apertures from a single chamber may also be to direct multiple separate neutral atomic beams towards different locations.

Of course, the passage 135 need not always be facing in the opposing direction to the passage 134. For instance, in embodiments, the passage 135 may be through a side surface of the first housing 108 so as to be a side-facing passage 135.

As shown in FIG. 4B, the first housing 108 may comprise a single chamber, wherein each one of the plurality of passages 134 is from the interior 109 of the single chamber to an exterior of the first housing 108.

The oven assembly 104 may be formed from an integral piece consisting of the first housing 108, the second housing 120, and the one or supports 124.

Alternatively, the oven assembly 104 may be formed from a plurality of pieces, as shown in FIGS. 5A-5D. Referring now to FIGS. 5A-5D, the oven assembly 104 is formed from a first piece 104a and a second piece 104b. Each piece 104a, 104b has one or more respective mating surfaces configured, in use, to contact the corresponding mating surfaces of the other piece 104a, 104b so as to form the completed oven assembly 104.

The mating surfaces may mutually align with high precision. In some embodiments, the mating surfaces may comprise corresponding steps and/or protrusions and recesses, which may for example provide mutual mechanical support in one or more radial directions.

The pieces 104a, 104b may be fabricated from substrates, wherein the substrates have abrasively polished surfaces prior to fabrication of the pieces 104a, 104b. The pieces 104a, 104b may be formed from said substrates, e.g. via laser-assisted etching processes. The pieces 104a, 104b may be formed in such a way such that some if the abrasively polished surfaces if the substrates are not etched so as to form the mating surfaces of the finished two pieces. Alternatively, the mating surfaces may be machined from the substrates, e.g., via laser-assisted etching processes, and are subsequently polished via laser ablation or laser-annealing.

The first piece 104a provides the first housing 108, at least a portion of the second housing 120 (as shown in FIGS. 5C and 5D), and at least a portion of the one or more supports 124. The second piece provides at least one cap 111 configured to engage with the first housing 108 so as to form at least one interior chamber (e.g. a single internal volume 109 similar to that shown in FIG. 4B, or a plurality of internal chambers 109a, 109b similar to that shown in FIG. 4A) in which the atomic source material (not shown in FIGS. 5A-5D) is housed so as to seal the atomic source material within the at least one interior chamber.

The second piece 104b, such as the at least one cap 111, may be bonded to the first piece 104a via any number of bonding mechanisms, such as by anodic, optical contact, eutectic, thermos-compression, adhesive, brazed or sintered bonds. Alternatively or additionally, the at least one cap 111 may be attached to the first housing 108 by a clip (as shown in FIG. 5C) or by a friction fit (as shown in FIG. 5B). In embodiments, the clip may bias the cap 111 onto the first housing 108 so as to seal the first housing 108 with a clamping force so as to seal off the interior volume 109. The clamping force may be around 1 mN.

Referring to FIG. 5A, the cap 111 may provide the at least one passage 134 of the oven assembly 104. For instance, the first housing 108 may be closed other than for an open end 136. The cap 111 may include at least one cap passage therethrough, such that the first housing 108 may then be closed or sealed by the cap 111 except for the at least one passage 134 which fluidically connects the interior of the first housing 108 to an exterior (i.e. an exterior of the first housing and the cap 111). That is, when engaged with the first housing 108, the cap 111 may provide the at least one passage 134 of the oven assembly 104.

Referring to FIG. 5B, the first housing 108 comprises both at least one passage 134 (such as three passages 134 as shown) and an open end 136, wherein the open end 136 which has a diameter which is larger and any of the at least one passage 134. At least one of the passages 134 may be closed via a cap 111a of the one or more caps 111. As will be appreciated, any number of the passages 134 may also be closed by similar caps 111a such that the oven assembly is adaptable to provide, for instance, a single passage 134, or various differently configured arrays of passages 134. The open end 136 is closed by another cap 111b of the one or more caps 111. It will be appreciated that a similar cap to cap 111a in FIG. 5B may be applied to the passages 134 provided by the cap 111 of FIG. 5A.

Referring to FIG. 5D, the second piece 104b provides an outer cap housing 121 and one or more cap supports 125 which support the cap 111 relative to the outer cap housing 121 (the one or more cap supports 125 are also shown in the embodiment of FIG. 5A). The outer cap housing 121 of the second piece 104b may be configured to match at least a portion of the second housing 120 of the first piece 104a.

The second piece 104b may be arranged and configured to engage with the first piece 104a such that the one or more cap supports 125 bias the at least one cap 111 against the first housing 108 so as to seal the first housing 108 with the at least one cap 111. For instance, as shown in FIG. 5D, the cap supports 125 may be sprung supports which, when the cap housing 121 of the second piece 104b is engaged with at least a portion of the second housing 120 of the first piece 104a, bias the cap 11 towards the first housing 108.

As shown in FIG. 5D, both the one or more cap supports 125 and the one or more supports 124 may be sprung supports, which may protect the first housing and cap 111 from external forces or shocks exerted on the at least a portion of the second housing 120 and/or the cap housing 121.

It will be appreciated that, in use, the one or more caps 111 may be configured to be heated by the EM radiation 112, and in doing so heat the atomic source material housed within the first housing 108.

The second piece 104b is formed from a second homogeneous material. Preferably, the second piece 104b is formed from the same homogeneous material of the first piece 104a. Each of the first 104a and second 104b pieces may be an integral piece.

In some embodiments, the volume of the interior of the first housing 108, or the volume of the interior formed by the first housing and the one or more passages 134, may be less than 0.001 mm³, between 0.001 mm³ and 0.01 mm³, between 0.01 mm³ and 0.1 mm³, between 0.1 mm³ and 1 mm³, or greater than 1 mm³.

The atomic source material may be loaded into the first housing 108 prior to engagement of the one or more caps 111. Additionally, or alternatively, the atomic source material may be loaded into the first housing 108 via insertion through the one or more passages 134. Alternatively or additionally, the atomic source material may be placed on an inner surface of the first housing 108 during fabrication of the first housing 108. Additionally or alternatively, the atomic source material may be loaded onto a surface of the one or more caps 111 prior to engagement with the first housing 108.

The atomic source material may for example be calcium, such as powdered calcium. The atomic source material may also be liquid and loaded into the first housing 108 under inert gas. The atomic source material may be a material other than calcium, for example other group II elements such as strontium. Accordingly, the atomic source material may be group-II (alkaline-earth elements) such as Be, Mg, Ca, Sr, Ba and/or Ra; Lanthanides such as Yb, Dy and/or Er; group-I (alkali elements) such as Li, Na and/or K. The atomic source material may be Al.

The atomic source material may be comparatively low-melting point metals such as Rb, Cs or Hg.

The oven assembly may be heated so as to produce a solid-vapour equilibrium within the first housing. Substantial vapour pressure (vs the surrounding environment, e.g. surrounding vacuum) may typically be achieved several hundred Kelvin below the melting point of the atomic source material.

FIGS. 6A-6C show face-on views of the oven assembly 104, according to embodiments.

Referring to FIG. 6A, the first housing 108 is held in a fixed position relative to the second housing 120 by one or more supports 124 which are spokes, such as substantially linear spokes.

Referring to FIG. 6B, the first housing 108 is held in a fixed position relative to the second housing 120 by supports 124 which are spiral spokes.

Referring to FIG. 6C, the first housing 108 is held in a fixed position relative to the second housing 120 by supports 124 which are a series of counter-rotating spiral spokes designed to provide rigid support while maximising the thermal conductive path length to the second housing 120.

Referring to FIG. 6D, the first housing 108 is held in a fixed position relative to the second housing 120 by a single support 124 which is a membrane, such as a substantially planar membrane.

The supports 124 are preferably designed and optimised to offer stiff mechanical support in most directions, optionally with a controlled degree of tolerance for the seal of the cap 111 along the direction for engagement with the first housing 108 (i.e. when some supports also support the cap 111, the supports may be configured such that the cap 111 can be engaged with and biased against the first housing 108 so as to seal the first housing 108 with the cap 111), whilst maintaining a very high thermal isolation against conductive thermal losses between the first housing 108 and the second housing 120. Therefore, preferably, the supports 124 comprise a series of counter-rotating spiral spokes as shown in FIG. 6C, which increases the thermal conductive path length to the second housing 120 whilst providing rigid support of the first housing 108. For example, as shown in FIG. 6C, the counter-rotating spiral supports 124 may form a configuration which trace a rose-petal shape, wherein pairs of counter-rotating spiral spoke set 124 may meet at junctions 138 to form the tip of each rose-petal shape. However, the maximum length achievable (for a given arm thickness) is limited by the finite length of the intersection regions, which provide a thermal “shortcuts”.

Therefore, alternatively or additionally, the supports 124 may comprise a series of counter-rotating spiral spokes which do not mechanically intersect at junctions, for instance as shown in FIG. 6B. The first housing 108 may be held in a fixed position relative to the second housing 120 by a first set of spiral spokes rotating in a first direction and an axially-shifted second set of spiral spokes rotating in a second direction opposite to the first direction such that each spoke of the first and second sets does not mechanically intersect any other spoke of the first and second sets. As will be understood, this prevents problems with intersections, and may allow a much higher thermal impedance, but at the expense of lower mechanical stability.

Each of the supports 124 may have a substantially square cross-section. Alternatively, each of the supports 124 may have a substantially rectangular cross-section. As will be understood, supports with a rectangular cross-section may for example provide greater axial support along the central axis of the oven assembly 104, as compared to supports with a square cross-section.

However, the higher quantity of material required to form a rectangular cross-section support may also increase the amount of heat which is conducted from the first housing 108 to the second housing 120, as compared to a square cross-section support. Accordingly, the supports 124 are preferably designed and optimised to offer stiff mechanical support in most directions, and optionally with a controlled degree of tolerance for the seal of the cap 111 in the axial direction along the central axis (i.e. when some supports also support the cap 111, the supports may be configured such that the cap 111 can be engaged with and biased against the first housing 108 in the axial direction so as to seal the first housing 108 with the cap 111), whilst maintaining a very high thermal isolation against conductive thermal losses between the first housing 108 and the second housing 120.

In embodiments, each of the supports has a cross-section having one of: a circular shape, an elliptical shape, a regular polygonal shape or an irregular polygonal shape, wherein the cross-section is taken at a point along a support and is in the plane wherein the tangential direction of the support at that point is the surface normal of the plane. In embodiments, the supports can have uniform cross-sections, uniform curvatures, and uniform path lengths.

In alternative embodiments, the supports can have varying cross-sections as a function of position along the support, and optionally or alternatively may have a non-uniform curvature. Moreover, in embodiments having a plurality of supports, one or more of the supports may have different characteristics (such as cross-section and/or path length) from the other supports of the plurality of supports.

Each support may have a total length, measured from the end connecting to the inner housing to the end connecting to the outer housing, of between 0.5 mm and 2.5 cm. Each support may have a total length of less than 0.5 mm, or greater than 2.5 cm.

Similarly, in embodiments including one or more cap supports 125, the one or more cap supports may have one or more of the features of the one or more supports 124 described above. For instance, the cap supports 125 may comprise two sets of counter-rotating spiral spokes 125 to hold the cap 111 in a fixed position relative to the outer cap housing 121, wherein the two sets of counter-rotating spiral spokes are in the same plane such that spokes from either set mechanically intersect with each other in a similar fashion as described above.

As shown in FIGS. 1A-1C, the passage 134 simply may be an aperture within a wall of the first housing. Alternatively, as shown in FIGS. 2, 4B and 4C, and 5A-5D, the passage 134 may be a substantially linear channel having an aspect ratio, defined as the ratio of the length with respect to the diameter, such that the spatially propagating neutral atoms are collimated through the at least one passage from the interior to the exterior of the first housing 108 so as to form a neutral atomic beam. For instance, the aspect ratio may be one of: between 2:1 and 10:1, between 10:1 and 30:1, between 30:1 and 50:1, or greater than 50:1. Preferably, the aspect ratio is around 33:1.

As shown in FIGS. 4A and 4B, and 5A and 5B, the oven assembly 104 may comprise a plurality of passages 134, provided by the first housing 108 and/or the at least one cap 111, which are arranged substantially in parallel so as to form an array of distinct ensembles of spatially propagating atoms, such as an array of substantially parallel neutral atomic beams.

The oven assembly 104 may further comprise a metallic layer on an outer surface of the oven assembly 104.

In embodiments in which the oven assembly comprises an integral piece, or in embodiments in which the oven assembly comprises two pieces 104a, 104b, the piece(s) may be produced via laser-enhanced etching or laser-assisted etching. The piece(s) be formed from a silica body, for example pure fused silica. The piece(s) may be manufactured or micro-fabricated from a single monolithic block of fused silica via femtosecond-laser-assisted chemical etching. The silica piece(s) may then be coated in a thin metallic layer, for example by sputter coating in a Ti/Au stack, which helps to ensure that blackbody emissivity from the surfaces of the silica piece(s) is reduced to the percentage level, such as less than 10%. This reduction in emissivity makes radiative losses insignificant when operating the oven at the necessary temperatures for ion loading.

In embodiments, the coating may be achieved via magnetron sputtering. The thin metallic layer may be at least 10 nm in thickness. In embodiments comprising a Ti/Au coating, the coating thickness (Ti:Au) may be between 10 nm: 70 nm and 30 nm: 300 nm.

In an embodiment, the entire assembled oven assembly 104 may have a diameter of approximately 3 mm and a depth of approximately 2 mm, however it will be understood that substantially smaller oven assemblies may be fabricated. As will be understood, the design is compatible with a scalable method of manufacture.

After coating, a small region of the coating may be ablated or otherwise removed to form an uncoated heating region (e.g. heating region 102 in FIG. 1A) to allow ingress of the EM radiation 112 during operation. Alternatively, a small region may be treated prior to coating such that the small region remains uncoated during the coating procedure. As will be understood, the EM radiation 112 may be directed so as to be incident on the uncoated heating laser region.

In embodiments in which the EM radiation 112 is directed through the passage 134, the interior facing surface of the first housing 108 may be left uncoated.

As a result of reducing radiative losses to the environment due to the coating of the oven assembly 104, the first housing 108 may be maintained at a high operating temperature (typically 400-800 K) with minimal total losses.

In embodiments, the coating on the interior facing surfaces of the inner housing 108 may also be ablated or otherwise removed (or treated prior to coating such that the interior facing surfaces remain uncoated), so as to maximise transfer of heat from the interior facing surfaces of the inner housing 108 to the atomic source material 110 housed therein.

In some embodiments, the oven assembly 104 may be formed from carbon-based materials and/or amorphous materials, as well as from silica, and the body so formed may then be coated in a different metallic layer, such as Pt/Au. It will be understood that many materials may be suitable for the body of the oven assembly 104, as long as they have high mechanical stability or strength, and a low thermal conductivity.

The EM radiation source 106 may be a continuous wave laser, which may have a wavelength of 2.7 microns, for example to target the corresponding absorption line of silica. However, it will be appreciated that the wavelength of the heating laser is in general unimportant if absorbing via multiple scatters within the oven assembly 104. In embodiments, the laser will have a wavelength corresponding to a prominent absorption line of the material from which the body of the oven assembly 104 is constructed. Moreover, the spectral quality of the laser beam 112 is also not critical. The power requirements of the laser may generally be only a few milliwatts.

### Collimator

A portion of the first housing 108 may extend away from the internal volume 109 of the first housing 108 and may provide the one or more passages 134 therethrough with a relatively large aspect ratio, for instance so as to substantially collimate liberated neutral atoms passing therethrough to form a neutral atomic beam. This portion may therefore be referred to as a collimator 122, as shown in particular in FIGS. 7A and 7B, which show cross-sections along the middle-plane of two different embodiments of collimator geometries. In these two figures, the plurality of supports 124 are shown as annular discs spanning between the first 108 and second 120 housings (FIG. 7B) or between the first 108 and second 120 housings as well as between the second housing 120 and the collimator 122 (FIG. 7A).

In embodiments comprising a collimator 122, the uncoated heating region may be located on or adjacent to the collimator 122 (which may help to ensure that the collimator 122 is the highest temperature region of the oven assembly 204).

The oven assembly 104 may be configured such that the EM radiation 112 irradiates the collimator 122, such as being incident on the outwardly facing surface of the collimator 222, e.g. the surface which is directed towards the target region 118 in FIG. 3A. Heating of the inner housing 108 may therefore be achieved via thermal conduction from the collimator 122 which is itself heated via absorbing the incident laser beam 112. As will be appreciated, atomic ovens (e.g. for ion trap experiments) have conventionally avoided use of collimators, as the thin capillaries thereof can easily become clogged unless reliably maintained at a higher temperature than the rest of the oven.

However, the inventors have additionally discovered that embodiments of the present invention help to ensure that the collimator 122 is always the hottest region of the oven assembly 104, which prevents such blockages as a result. The collimator 122 may be orientated so as to direct atoms exiting the passage 134 as an atomic beam 114 towards target region 118. The collimator geometry therefore may help to ensure that nearly every atom emitted by the oven assembly 104 passes through the target region 118 (e.g. ion trapping region 118). As a result, the arrangements of the present invention provide an exceptionally high geometric efficiency.

Upon heating of the first housing 108 (in particular, heating via thermal conduction of heat generated by the collimator 122 upon absorption of the EM radiation 112 by the collimator 122) at least some atoms are liberated from the atomic source material housed within the inner housing 108 and a relatively weak but well-collimated and stable flux will be emitted from the passage 134 of the collimator 122. In embodiments, as the collimator 122 is the highest temperature region of the system, atomic material deposition (e.g. via condensation) within the passage 134 of the collimator 122 is prevented such that the passage 134 experiences minimal or substantially no blocking.

Furthermore, as shown in FIG. 7B, the collimator 122 of oven assembly 104 protrudes so as to extend a distance 138 out from the front face of the second housing 120 (i.e. the face directed towards the target region 118) of oven assembly 104. As will be understood, this configuration enables the collimator 122 to be irradiated by an EM radiation source, such as a laser, from a substantially radial direction (i.e. via a beam incident along an axis which is orthogonal to the central or symmetry axis of the oven assembly, e.g. the axis orthogonal to that along which the passage 134 of collimator 122 is directed).

FIG. 7A shows oven assembly 104 having a low isolation of the collimator 122 from the first housing 108 results in a weaker temperature differential. Accordingly, the collimator 122 of FIG. 7A is configured for axial heating via EM radiation (that is, via EM radiation being incident on the front face as shown in FIGS. 1B, and 3A and 3B).

FIG. 7B shows oven assembly 104 having a collimator 122 which protrudes so as to increase the temperature differential and allows for radial heating via EM radiation (as described above) as well as axial heating via EM radiation.

Although the collimators 122 shown in FIGS. 7A and 7B are shown as part of a two-piece oven assembly, it will be understood that a collimator 122 may be provided in embodiments in which the entire oven assembly is formed from a single piece.

### Optical Fibre

FIG. 8 shows a cross-sectional side-on view of three stages (A)-(C) for configuring a system 100 for producing spatially propagating neutral atoms. Here, the system 100 includes an oven assembly 104 and an EM radiation source 106 for creating EM radiation 112. The EM radiation source 106 is coupled to the oven assembly 104 by an optical fibre 107 which transmits the EM radiation 112 from the source 106 to the oven assembly 104. As shown, the interior chamber 109 of the first housing 108 of the oven assembly 104 has a front-facing passage forming collimator 122 and a back-facing passage 135. The collimator 122 comprises a substantially conical body surrounding front-facing passage therethrough. As will be appreciated, the collimator 122 having a conical body may enable the oven assembly 104 to be positioned closer to target region 118 (e.g. the exit of the passage of collimator 122 may be positioned closer to target region 118).

In stage (A), source material 110 is inserted through the back-facing passage 135 into the interior 109 of the first housing 108.

In stage (B), the back-facing passage 135 is plugged via the optical fibre 107. The end of the optical fibre may be held in the back-facing passage 135 via an interference fit.

In stage (C), the optical fibre 107 is coupled to the EM radiation source 106 and EM radiation 112 from the EM radiation source 106 is transmitted through the optical fibre 107 into the interior 109 of the first housing 108. In this way, the EM radiation 112 may impinge directly on the source material 110 (or at the very least directly on an interior surface of the first housing 108). As will be appreciated, this may result in a higher efficiency of energy transmission to the source material 110 housed within the interior 109 of the first housing 108. The atomic source material 110 housed within the first housing 108 is thus heated such that atoms are liberated from the source material 110 and form spatially propagating neutral atoms, such as a neutral atomic beam 114, as discussed above.

Of course, the optical fibre 107 need not always plug a back-facing passage 135 (or indeed a side-facing passage 135, as appropriate). For instance, in embodiments, the optical fibre 107 may be positioned in contact with or adjacent to a surface (e.g. exterior surface) of the first housing 108, regardless of whether or not the first housing 108 has the passage 135. As will be appreciated, this set-up will still retain the benefit of providing EM radiation 112 to the first housing 108 when direct line of sight from the EM radiation source 106 to the oven assembly 104 is not possible.

### Outermost Housing

The oven assembly 104 may comprise a third, outermost housing 140, which at least partially surrounds the second housing, as shown in FIGS. 9A and 9B. Referring to FIGS. 9A and 9B, the oven assembly 104 is formed from a first piece 104a and a second piece 104b (e.g. as described above with respect to FIG. 5D). The pieces 104a, 104b together provide the first housing 108, the second housing 120 and the supports 124, as described above (and as shown in FIG. 9B). The oven assembly further includes a further third housing 140, which is an outermost housing 140.

The outermost housing 140 has a passage 146 at one end and an opening at another end which opens onto an interior volume of the outermost housing 140 for receiving the first 104a and second 104b pieces via a tolerance fit. The first 104a and second 104b pieces may be inserted through the opening such that the collimator 122 (or the passage 134, as appropriate) faces the passage 146 of the outermost housing 140. A stop 148 is provided on the interior surface of the outermost housing 146 to prevent further insertion of the first 104a and second 104b pieces in the direction towards the passage 146. This prevents contact of the collimator 122 with an interior surface of the outermost housing 146, which may prevent damage to the collimator 122.

The diameter of the passage 146 is larger than the diameter of the passage 134 of the collimator 122, such that the spatially propagating neutral atoms exiting the passage 134 of the collimator 122 are substantially not restricted or impeded by the interior surface of the passage 146 of the outermost housing.

The outermost housing 140 includes a cap 142 for closing the opening and a clip 144 for biasing the cap 142 onto the second piece 104b, when the first 104a and second 104b pieces are received within the interior volume of the outermost housing 140. The cap 142 is biased by the clip 144 against the second piece 104b, such that the first 104a and second 104b pieces are pushed together against the stop 148. As will be appreciated, the clip 144 may be configured to flex outwardly as the cap 142 is initially inserted into the opening of the outermost housing 146, and may be configured to subsequently clip inwards and further bias the cap 142 in the direction towards the passage 146 after the cap 142 has been inserted a certain distance into the outermost housing 146.

In this manner, the first 104a and second 104b pieces are securely held together within the outermost housing 146 so as to be protected by the outermost housing 146. That is, the outermost housing may be held and manoeuvered by a user with less risk of damaging the more delicate first 104a and second 104b pieces secured therein. Moreover, the oven assembly 104 may be orientated in any direction without the 104a and second 104b pieces coming apart due to gravity, and further facilitates the handling and orientation of the assembly components during the process of adding source material. As such, the oven assembly 104 including the outermost housing 104 is particularly robust.

As will be appreciated, the cap 142 may include an aperture through which an optical fibre 107 may be inserted such that the source material 110 housed within the over assembly may be heated in the manner described above in reference to FIG. 8. As will be appreciated, as the aperture in the cap 142 for receiving the optical fibre 107 is further away from the interior 109 of the oven assembly which is the hottest region, the aperture in the cap 142 will be relatively cooler. As such, an adhesive may advantageously be used in the aperture of the cap 142 to secure a portion of the optical fibre 107 to the cap 142.

The cap 142, the outermost housing 140, the first pieces 104a and the second piece 104b may all be formed form the same homogenous material as described herein, e.g. silica.

### Oven Operation

The inventors have additionally discovered that the system 100, with or without collimator 122, can be run “steady-state” e.g. always on. As will be understood, if the system 100 can be run steady-state, then loading of neutral atoms generated from the oven assembly 104 (e.g. the neutral atomic beam 114) into the target region 118 which is an ion trapping region can be controlled purely through application of photo-ionisation laser pulses (which are distinct from laser beam 112), which is effectively instantaneous at the relevant timescales. An exceptionally low total flux of atoms released from the oven is required to allow steady state operation without pollution of a surrounding evacuated ultra-high vacuum environment.

The flux required to load a typical ion trap rapidly is ˜1000 per second passing through an ionisation region, however conventional ovens emit atoms into a half sphere, and only 10 ppm of these pass through the target ion trapping region. In contrast, due to the features of the present invention, such as the quality of the collimation, precision of delivery, close positioning of the oven assembly to target regions (due to the low thermal load of the oven assembly into the surrounding system) and/or controlled energy input from the EM radiation 112 to the oven assembly 104, a relatively weak or sparse ensemble of spatially propagating neutral atoms (e.g. a weak neutral atomic beam) 114 may be generated which has a flux that is many orders of magnitude lower than conventional oven designs. As a result, the level of flux of neutral atoms may have a negligible effect on the quality of the vacuum so as to be suitable for operation under the exacting conditions demanded, e.g. by ion trap quantum computing operations.

In embodiments, the oven assembly 104 in use may generate an ensemble of spatially propagating neutral atoms 114 having a flux of: less than 100 atoms/s, between 100 and 1000 atoms/s, between 1000 and 2000 atoms/s, or greater than 2000 atoms/s. Preferably, the ensemble of spatially propagating neutral atoms 114 is generated with a flux of around 750 atoms/s.

In addition, without wishing to be bound by theory, it is believed that initial “cracking” of the oven assembly 104 may no longer present a threat to shorting, coating, or otherwise damaging components within the broader surrounding system, such as an ion trapping system (e.g. ion trap electrodes 117 associated with an ion trapping region 118). As will be understood, cracking is the process of removing an oxide layer which may have formed on the source material. For example, an oxide layer may form during loading of atomic material within a typical oven.

Accordingly, initial operation of a typical oven may require uncontrolled high-temperature cracking of the oxide layer on the source metal. Typical ovens may therefore require further complicated mechanisms to temporarily block the produced atomic beam during the cracking operation so as to avoid shorting and contaminating of trap electrodes 117. In contrast, in embodiments, the passage 134 or collimator 122 forces any ejected contaminants to be directed into a controlled region of the surrounding structure, which can be designed to serve as a “dump” for the atomic beam. This removes the need for complicated mechanisms for blocking the oven beam during bakeout and commissioning.

In embodiments, the ‘smallest possible’ version of the oven assembly according to embodiments described herein is determined via constraints of the fabrication method. For example, at present day conventional fabrication limits, a minimum collimator diameter may be 5 microns, and a minimum positive feature width of 10 microns (below which the reliability of the process is very poor), an oven assembly can be conceived that is little more than 0.5 mm in any dimension. As will be understood, advancements in fabrication processes are likely to enable the fabrication of oven assemblies with a size of less than 0.5 mm in any dimension.

Conventional ovens typically contain enough calcium (or other atomic source material) for hundreds of thousands of years of operation, i.e. they are far bigger than they need to be. Indeed, a simple pinhole source of 0.05 mm³ volume is more than sufficient, whereas (with suitable collimation) sources of ˜1 micron cubed would be sufficient for hundreds of years of operation. Manufacturing such small devices necessitates microfabrication techniques. This can potentially increase complexity if making oven assemblies consisting of an inhomogeneous mix of different parts, such as insulating and conductive parts necessary for electrically heated oven assemblies. However, in contrast, the oven assembly of the present invention may be fabricated from homogeneous components, which is relatively less complex—and new techniques such as laser-enhanced etching make micro-scale precision manufacture of glass devices simple and cheap even at low-scale.

Accordingly, in embodiments the oven assembly has a diameter in any dimension of: 0.001 mm-0.01 mm, 0.01 mm-0.1 mm, 0.1 mm-0.5 mm, 0.5 mm-1 mm, 1 mm-5 mm, or greater than 5 mm.

Accordingly, the design parameters of the oven assembly may be optimised to maximise performance metrics via tuning, for example, the support thickness, support spiral pitch, collimator capillary, and/or collimator geometry, as well as the relative dimensions of the various components of the oven assembly and the overall size of the oven assembly. The performance metrics to be maximised may be, for example, geometric efficiency of the atomic beam, velocity of the atomic beam, and/or thermal conduction from the oven assembly to the surrounding system.

The low thermal losses inherent in the design prevent excessive heating of the surrounding trap and associated subsystems during operation, and such that the present system 100 is compatible with 4K-cryogenic ion trap systems. Heat loss at the target operating temperature (e.g., between 400K-500K) may be: 20 mW, 15 mW-20 mW, 10 mW-15 mW, 5 mW-10 mW, 2 mW-5 mW, or less than 2 mW. Operation within a 4 K cryogenic environment would increase these values by ˜60%, but in both cases the impact on cryogenic heat load remains minimal. The near-homogenous construction and largely low degree of thermal expansion (e.g. for an oven assembly comprising a body formed from pure fused silica, and with a sputtered Ti/Au coating) makes cryogenic performance predictable and realistic without further modification.

The low thermal losses of the present invention offers a radically reduced power dissipation compared to existing thermal oven designs, and permit the oven assemblies described herein (which may be located, e.g. within an ion trap) to be operated continuously with no “warm-up” time, for instance offering the means to load ions near-instantaneously.

Therefore, the inventors have discovered that the oven assemblies described herein provide a means of reliably producing an atomic flux of suitable intensity, with minimal latency, and minimal associated perturbation of the vacuum or trapping potential of the associated ion trapping region. Furthermore, the oven assemblies described herein have a low-complexity design so as to be are simple and cheap to construct, will have very low power requirements, and can be implemented in both room temperature or cryogenic environments. Moreover, the oven assemblies described herein are small enough to be integrated within the structure of an ion trap “chip”, allowing the source to be located much closer to the target loading region than typical alternatives.

Embodiments of the present invention allow the oven assembly to be placed very close from the desired target region with negligible thermal impact to the surrounding structure, whilst helping to ensure micron level transverse alignment of the atomic beam to the target, and with negligible tilt. For instance, the oven assembly may be located at a position from the target region of: less than 0.1 mm, between 0.1 mm and 1 mm, between 1 mm and 5 mm, or greater than 5 mm. Accordingly, embodiments of the present invention may achieve the collimation required to help ensure substantially 100% geometric efficiency and complete suppression of atomic flux onto other system components, e.g. such as surrounding electrodes 117.

### Numerical Results

As will be appreciated, embodiments of the present invention help to ensure that the oven assembly 104 is highly thermally insulated, with lower power losses at, or below, 1 mW. Moreover, the system can be configured to continuously generate a neutral atomic beam at a relatively low flux.

In embodiments, the collimator 122 may be less susceptible to blocking up by liberated atoms adhering to the inner surface of the collimator channel due to the low atomic flux passing therethrough (in addition to being provided at a higher temperature than the inner housing).

FIG. 10 shows a polar plot showing the percentage of atomic flux in an atomic beam that is within a given angle from the atomic beam axis from the collimator having different aspect ratios. The aspect ratio is the length of collimator with respect to the collimator diameter, and Γ=0 represents an orifice (i.e. with vanishingly small collimator length). These are all normalised to have the same diameter.

In embodiments, the high geometric efficiency of the present invention, combined with the low and steady heat load to the surrounding system components, means that operation of the present oven assembly is not expected to increase background pressure within a surrounding system, such as an ultra-high vacuum, in which the components reside. Indeed, the rate of effusion of, e.g. calcium atoms leads to a calcium pressure within the trap itself that is several orders of magnitude below that of the vacuum base pressure at room temperature.

Although the present invention has been described with reference to preferred embodiments, it will be understood by those skilled in the art that various changes in form and detail may be made without departing from the scope of the invention as set forth in the accompanying claims.

1. An oven assembly for producing spatially propagating neutral atoms, wherein the oven assembly comprises:
a first housing configured to house atomic source material;
at least one passage from an interior of the first housing to an exterior of the first housing;
a second housing; and
one or more supports, wherein the first housing is held in a fixed position relative to the second housing by the one or more supports;
wherein the first housing, the second housing and the one or more supports are formed from a first homogeneous material.

2. The oven assembly of claim 1, wherein the oven assembly comprises an integral piece comprising the first housing and the one or more supports.

3. The oven assembly of claim 2, wherein the integral piece consists of the first housing, the second housing, and the one or more supports, wherein the first housing comprises the at least one passage.

4. The oven assembly of claim 1, wherein the first housing is held in a fixed position relative to the second housing only by the one or more supports.

5. The oven assembly of claim 1, wherein:
(i) one or more regions of a surface of the first housing is configured to be heated by irradiation from a light source so as to liberate atoms from the atomic source material housed therein; and/or
(ii) the first housing is configured to house the atomic source material such that one or more regions of a surface of the atomic source material housed therein is configured to be heated by irradiation from a light source so as to liberate atoms from the atomic source material;
wherein the at least one passage is configured so as to allow the liberated atoms to pass therethrough to form the spatially propagating neutral atoms.

6. The oven assembly of claim 1, wherein the first housing is held in a fixed position within the second housing so as to be at least partially enclosed or surrounded by the second housing.

7. The oven assembly of claim 1, wherein the oven assembly comprises a plurality of passages, and wherein:
(i) the first housing comprises a plurality of chambers configured to house atomic source material, and wherein each one of the plurality of passages is from an interior of a respective one of the plurality of chambers to an exterior of the first housing; or
(ii) the first housing comprises a chamber configured to house atomic source material, and wherein each one of the plurality of passages is from an interior of the chamber to an exterior of the first housing.

8. The oven assembly of claim 7, wherein each one of the plurality of passages is from an interior of the chamber to an exterior of the first housing, and wherein a first passage of the plurality of passages is provided on a first side of the chamber and a second passage of the plurality of passages is provided on a second side of the chamber opposing the first.

9. The oven assembly of any-preceding-claim 1, comprising:
a first piece comprising the first housing, at least a portion of the second housing, and at least a portion of the one or more supports; and
a second piece comprising at least one cap configured to engage with the first housing.

10. The oven assembly of claim 9, wherein the second piece is bonded to the first piece, for instance by anodic, optical contact, eutectic, thermocompression, adhesive, brazed or sintered bonds.

11. The oven assembly of claim 9, wherein the at least one cap is attached to the first housing by clips or friction fit.

12. The oven assembly of claim 9, wherein the second piece further comprises an outer cap housing, and one or more cap supports, wherein the at least one cap is held in a fixed position relative to the outer cap housing by the one or more cap supports, optionally wherein, when the second piece is arranged and configured to engage with the first piece, the one or more cap supports is configured to bias the at least one cap against the first housing so as to seal the first housing with the at least one cap.

13. The oven assembly of claim 9, wherein the second piece is formed from a second homogeneous material.

14. The oven assembly of claim 13, wherein the first homogenous material and the second homogeneous material are the same homogenous material.

15. The oven assembly of claim 7, wherein each of the first and second pieces is an integral piece.

16. The oven assembly of claim 7, wherein the at least one cap comprises at least one cap passage therethrough so as to provide, when engaged with the first housing, the at least one passage, so as to fluidically connect an interior of the first housing to an exterior of the at least one cap.

17. The oven assembly of claim 7, wherein the first housing comprises the at least one passage, and wherein the at least one cap comprises at least one cap passage therethrough;
wherein, when the at least one cap is engaged with the first housing, the at least one passage is provided on an opposing side of an interior of the first housing to the at least one cap passage.

18. The oven assembly of claim 7, further comprising a third housing, wherein the third housing at least partially surrounds the first piece and the second piece, wherein the third housing is configured to bias the first piece and the second piece together so as to seal the first housing with the at least one cap.

19. The oven assembly of claim 18, wherein third housing comprises:
a third housing cap;
a clip; and
a stop on an interior surface of the third housing;
wherein the clip is configured to bias the third housing cap in a direction towards the top so as to bias the first and second pieces together against the stop.

20. The oven assembly of claim 19, wherein the third housing cap comprises an aperture therethrough.

21. The oven assembly of claim 1, wherein the one or more supports, or the one or more cap supports, comprise one or more of spokes, membranes, filaments or combinations thereof.

22. The oven assembly of claim 21, wherein the spokes comprise a plurality of spiral spokes.

23. The oven assembly of claim 22, wherein the plurality of spiral spokes comprise:
a first set of spiral spokes rotating in a first direction and a second set of spiral spokes rotating in a second direction opposite to the first direction, wherein at least one spiral spoke from one of the first or second sets mechanically intersects at least one spiral spoke from the other of the first or second sets; or
a first set of spiral spokes rotating in a first direction and a second set of spiral spokes rotating in a second direction opposite to the first direction, wherein each spoke of the first and second sets does not mechanically intersect any other spoke of the first and second sets.

24. The oven assembly of claim 1, wherein the at least one passage has an aspect ratio of at least 2:1, defined as the ratio of the length with respect to the diameter, such that the spatially propagating neutral atoms are collimated through the at least one passage from the interior to the exterior to form a neutral atomic beam.

25. The oven assembly of claim 24, wherein the aspect ratio is one of: between 2:1 and 10:1, between 10:1 and 30:1, between 30:1 and 50:1, or greater than 50:1.

26. The oven assembly of claim 1, comprising a plurality of passages arranged substantially in parallel so as to form an array of distinct spatially propagating neutral atoms.

27. The oven assembly of claim 1, further comprising a metallic layer on an outer surface region of the oven assembly, wherein the metallic layer has a thickness of at least 10 nm.

28. A system for producing spatially propagating neutral atoms, the system comprising:
an oven assembly for producing spatially propagating neutral atoms, wherein the oven assembly comprises:
a first housing configured to house atomic source material;
at least one passage from an interior of the first housing to an exterior of the first housing;
a second housing; and
one or more supports, wherein the first housing is held in a fixed position relative to the second housing by the one or more supports;
wherein the first housing, the second housing and the one or more supports are formed from a first homogeneous material; and
a heating mechanism for heating the oven assembly so as to liberate atoms from the atomic source material housed therein, and wherein the liberated atoms pass through the at least one passage to form the spatially propagating neutral atoms.

29. The system of claim 28, wherein the heating mechanism comprises a source of electromagnetic radiation configured to irradiate: one or more regions of a surface of the first housing configured to be heated by irradiation from the light source; and/or one or more regions of a surface of the at least one cap configured to be heated by irradiation from the light source; and/or one or more regions of a surface of the atomic source material.

30. The system of claim 29, wherein the system further comprises an optical fibre arranged to transmit radiation from the source to the oven assembly.

31. The system of claim 30, wherein an end of the optical fibre is inserted through an aperture of the first housing of the oven assembly so as to be configured to irradiate an interior surface of the first housing and/or the atomic source material.

32. The system of claim 28, wherein the source has a wavelength which substantially corresponds to a prominent absorption line of the first homogeneous material and/or the second homogeneous.

33. The system of claim 28, further comprising an ion trap, wherein the ion trap comprises an ion trapping region, wherein the at least one passage is configured to direct the atomic beam towards the ion trapping region.

34. A method for producing a neutral atomic beam using a system for producing spatially propagating neutral atoms, the system comprising:
an oven assembly for producing spatially propagating neutral atoms, wherein the oven assembly comprises:
a first housing configured to house atomic source material;
at least one passage from an interior of the first housing to an exterior of the first housing;
a second housing; and
one or more supports, wherein the first housing is held in a fixed position relative to the second housing by the one or more supports;
wherein the first housing, the second housing and the one or more supports are formed from a first homogeneous material; and
a heating mechanism for heating the oven a assembly so as to liberate atoms from the atomic source material housed therein, and wherein the liberated atoms pass through the at least one passage to form the spatially propagating neutral atoms;
the method comprising:
(i) with the heating mechanism, heating the oven assembly so as to liberate atoms from the atomic source material; and
(ii) producing the spatially propagating neutral atoms from at least some of the liberated atoms passing through the at least one passage.
